(19) United States
(12) Patent Application Publication
(10) Pub. No.: US 2016/0163229 A1
(43) Pub. Date: Jun. 9, 2016

(54) System for Driving Training and Method

(71) Applicant: Christopher J. Ihara, Aldie, VA (US)

(72) Inventor: Christopher J. Ihara, Aldie, VA (US)

(21) Appl. No.: 14/959,987

(22) Filed: Dec. 4, 2015

Related U.S. Application Data
(60) Provisional application No. 62/087,666, filed on Dec. 4, 2014.

(51) Int. Cl. G09B 19/16

(52) U.S. Cl. CPC G09B 19/167

(57) ABSTRACT

A system and method for driving training are disclosed. The system simulates three driving scenarios: lane selection, braking, and intersection clearance. The system features a control unit with vehicle position and speed inputs and signal light outputs so that the driver may react to actual external stimulus rather than imagined scenarios. The control unit increases the safety of the training exercises by removing operators or flagmen from the path of travel. It also provides more uniform training stimuli.

### CROSS-REFERENCES TO RELATED APPLICATIONS

This Application claims priority as a non-provisional perfection of prior filed U.S. Provisional Application No. 62/087,666, filed Dec. 4, 2015, and incorporates the entirety of the same herein by reference.

### FIELD OF THE INVENTION

The present invention relates to the field of training equipment and more particularly relates to a selection system whereby drivers are trained to make split-second choices as to operation and direction of a vehicle.

### BACKGROUND OF THE INVENTION

Driving an automobile often requires split-second decisions as to the direction of the vehicle. Unfortunately, the consequences of making a wrong decision in an automobile are often disastrous. This is especially true for first responders who are driving to an incident scene. While there are afforded legal requirements and protections to keep the first responder and other drivers safe and to reduce impediments to the first responder (i.e. other drivers pull over when they hear sirens), the speeds in which a first responder travels often make mistakes by that first responder even more disastrous. To this end, virtually all first responders are required, or at least recommended, to take extensive training in lane clearance and selection so that the first responder's evaluations and decisions will be not only correct but also decisive and quick. In many circumstances, such clearance training is also recommended for civilian drivers as it can be that effective in reducing the number of accidents overall.

Common training for tactical clearance decisions usually involves two exercises. The first common exercise is called one of several names: Emergency Lane Change, Accident Avoidance, Swerve and Avoid, or other similar names. A driver approaches a division in the road at speed. The road is usually divided into three or more lanes, right, left, and one or more center lanes. Either each lane has a light overhead, or at the edge of the course, serving as a lane signal or an instructor stands nearby to provide audible or visual signals. A trigger point for the signal is selected based on a pre- determined calculation to approximate a set reaction time for a vehicle traveling at a certain speed, usually this time is between one to two seconds. When the driver reaches the trigger point, the instructor either gives an audible command such as or “left” or “right”, waves a flag or points to the desired lane, or selects a lane and the lights indicate which lane the driver is to select, either by illuminating for invalid lanes, or by using a system of colors to indicate which lanes are invalid and which are clear for travel. This exercise trains the driver to recognize obstructions or other hazards in a roadway and to maneuver the vehicle into a clear path. The second variation of this exercise is to force the driver to come to an emergency stop by indicating no available lanes for travel.

The current methodologies for both variations are dependent upon human interaction. As such, there is no uniform application as to timing of the lane signal. While some systems have been developed which are dependent upon the vehicle triggering a location sensor at a specific point, the distance of which is calculated to provide a fixed reaction time, the speed of the vehicle is not taken into account when changing the signal. Thus drivers can cheat the system by driving a little slower to have more reaction time, or shortchange themselves by driving faster causing an ever shorter reaction time. The present methodologies also face a disadvantage when curves in a test track are considered. Curves can create parallax for the administrator and also will affect how a driver handles a course. In a curve, the vehicle may already be at the limit of its capabilities and a lane change mid-corner may be beyond the driver or vehicle's capabilities. Thus by adding a lane change exercise in a curve the instructor is able to force the student to analyze the area prior to corner entry and drive within the limits of driver and vehicle capabilities ensuring enough margin of safety remains to enable the driver to handle emergency maneuvers.

The second exercise is an intersection clearance exercise. A driver approaches a, usually, four-way intersection and practices looking at each roadway to “clear” the driver for entering the intersection safely. Unfortunately, this exercise tends to create bad habits since there is usually no actual visual stimulation in the exercise. The driver simply goes through the motion of turning his or her head to look down the intersection but doesn't really “see” anything and has no consequences for failing to ensure the way is clear before proceeding. Often this practice carries over to the real world where drivers will “go through the motions” of clearing an intersection without actually seeing other traffic. Also, there is no way for an instructor “see” what is in a driver's mind, so evaluation is practically impossible.

The present invention is a system and methodology which incorporates vehicle speed and position to create a standardized activation of random lane selection signals in the lane change exercise. The lane signals are also configurable for an innovative intersection clearance exercise where lane signals change to represent oncoming traffic in specific directions.

The present invention represents a departure from the prior art in that the training system of the present invention allows the instructor to select a specific reaction time and drivers must make a correct decision for either lane change or emergency braking within that time period. This allows for more consistent driver training in that drivers are presented with the same reaction time regardless of their vehicle speed. It also provides visual input which must be perceived and interpreted by the driver for intersection clearance, thereby reducing inattention to the exercise garnered by rote and dismissive training attempts. The present invention also adds an additional dimension of safety as it does not require the physical presence of an instructor on the driving course exposed to vehicular traffic as is the current practice.

### SUMMARY OF THE INVENTION

In view of the foregoing disadvantages inherent in the known types of training system, this invention provides a dual exercise training system which is more automatically governed. As such, the present invention's general purpose is to provide a new and improved training system that is easily operated, portable, incorporates and is configurable for at least two training exercises, can be integrated into existing light systems, and is less susceptible to human manipulation.

To accomplish these objectives, the system comprises a number of lane signals operably connected to a control unit. The control unit is likewise operably connected to a speed sensor and a position sensor. For the lane selection exercise, the position and speed sensor are used to calculate the ideal time in which lane signals may be actuated. For the intersection clearance exercise, the lane signals are actuated to simulate the presence of oncoming traffic from different directions, or directions where no traffic is present. The lights turn red to indicate oncoming traffic and green to indicate where traffic has yielded or is not present. The lights that turn red are randomly selected and will stay red for a random period of time before turning green. This helps simulate different vehicles, moving at different speeds with different braking abilities, as these “vehicles” yield to the driver.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic drawing showing the components of one embodiment of the invented system.

FIG. 2 is a schematic drawing showing the components integrated into a pre-existing light system.

FIG. 3 is a schematic showing the use of the invention in a lane selection exercise.

FIG. 4 is a schematic showing the use of the invention in an intersection clearance exercise.

### DETAILED DESCRIPTION OF THE PREFERRED EMBODIMENT

With reference now to the drawings, the preferred embodiment of the system is herein described. It should be noted that the articles “a”, “an”, and “the”, as used in this specification, include plural referents unless the content clearly dictates otherwise. It should be noted that the term “vehicle,” as used in this Specification and the appended claims, includes any personal conveyance apparatus. The term includes not only automobiles, as is depicted, but also motorcycles, trucks, tractors, bicycles, semis, or any other type of conveyance. While the test parameters for different vehicles will understandably be different, such adjustments are easily conceived and developed based upon this Specification and, as such, the testing parameters discussed herein should be seen as exemplary and non-limiting.

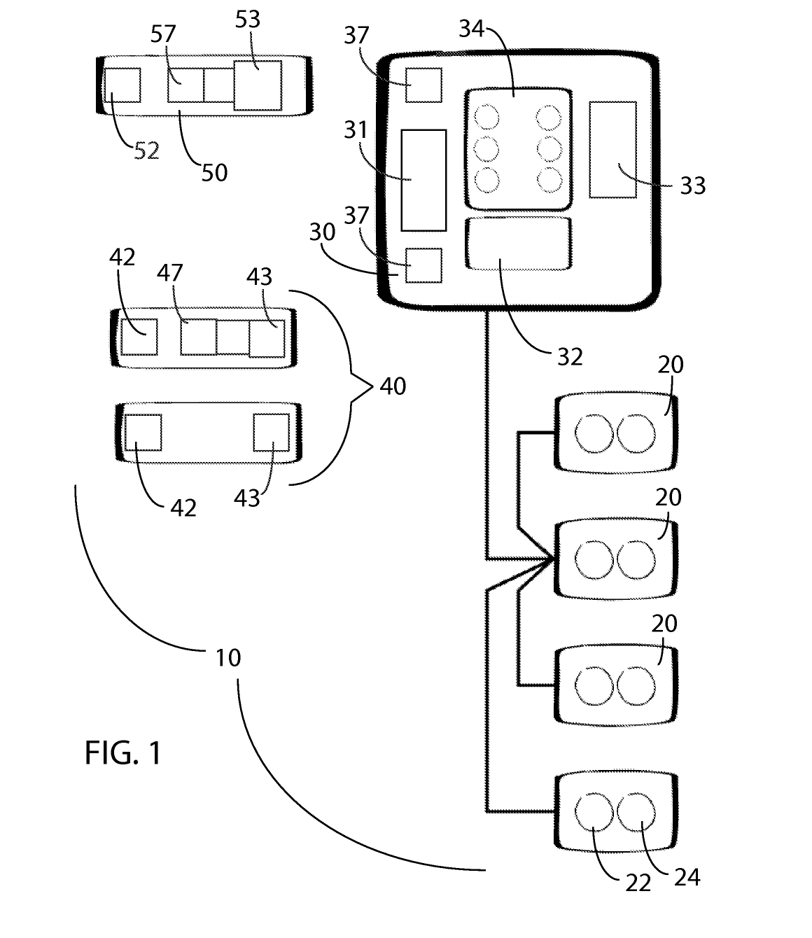

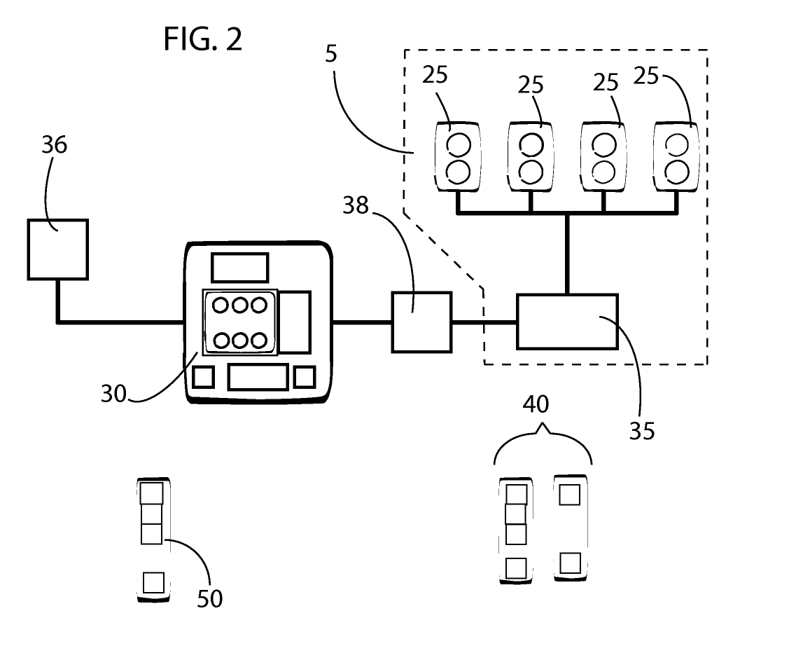

With reference to FIG. 1, an exemplary system 10 for driving training has at least three signal lights 20 connected to a control unit 30. While three lights may be sufficient for a basic functionality of the invention, more or fewer lights may easily be incorporated into the system, as is shown in FIG. 1. The control unit receives input from various sensors. The preferred location sensor 40 is an IR beam trigger 43 with a transmission and a receiving unit wirelessly 47 connected to the control unit 30. Wired connection is also possible. Other sensors include: magnetic induction switches, such as those in use in conventional traffic intersections; ultrasonic object sensors, such as those used in security or proximity sensors, air pressure switches, such as those used for traffic counting devices, RFID sensors such as those used in automated toll collection, all of which may be hardwired to the control unit or may be wirelessly connected, as is depicted with wireless control units 37, 47, 57 in each of the sensors 40, 50 and the control unit 30. Other sensors which may be capable of registering the presence of a vehicle at a given location which may be later developed may also be used. It is also useful to have a speed sensor 50, such as a traditional police RADAR or LIDAR unit 53, connected wired or wirelessly to the control unit 30, in order to calculate moving speed of a vehicle. In lieu of such a sensor, multiple location sensors and a timer may also be used to calculate speed. A keypad 34, keyboard, or wireless connectivity via computer, web browser, other wireless, or BLUETOOTH enabled device is provided for user input and a display 33 is provided for reporting status. The entire system may also be made to run wirelessly on an operator's personal computer or mobile device. Ideally, the whole unit and system is battery powered 32, 42, 52 but other options, including wired electricity and solar power, are possible. It should also be noted that a system may be integrated into existing signal systems, as shown in FIG. 2. In the depicted system which is powered through an AC/DC power adapter 36, a connection is made between an existing signal system 5 and a training system representing one embodiment of the invention. Hardware 38 for conversion of communication and control signals is provided to make the control unit 35 of the existing system 5 a slave to the control unit of the improved system 30, and thereby control the lights 25 of the existing system 5.

When utilizing wireless communication, it has been found that using two separate wireless modules can be helpful in facilitating the operation of the system. A single wireless module may be dedicated to communication between the speed sensor and the control module while another may be dedicated to other sensors and communication. This more efficiently allows the simultaneous reading of data from two, or more, separate sensors. It should also be noted that lower frequencies, around 900 MHz, tend to be preferred as higher frequencies may be more crowded in RF rich environments, such as airfields.

Once data is received from the speed and position sensors, the control unit microprocessor 31 will produce output based on an algorithm selected for the exercise. Output from the control unit 30 is directed to the signal lights 20. Signal lights 20 should have two different light colors, but may have three, similar to a traditional intersection traffic light. Ideal colors being red 22 and green 24, with yellow if a third light is utilized. A single light could also be used, but the apparatus would then have no clear indication if that single light was disabled. Communication with these output signal lights may be wired or wireless. The output to these lights will depend upon the chosen exercise. Likewise, the signal lights will be arranged in an array depending on the exercise chosen.

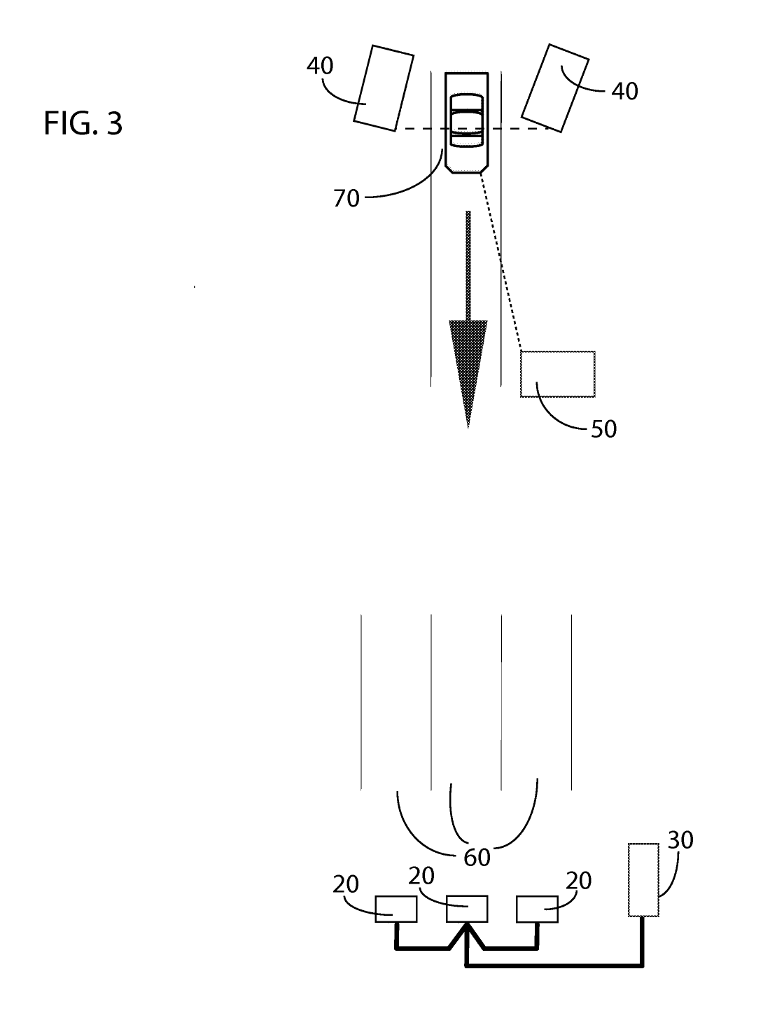

For the lane selection exercise, shown in FIG. 3, the signal lights 20 are situated directly above or at an end of a lane 60, each representing a number of different paths, three in the illustrated example, for an oncoming vehicle 70. In the exercise, the vehicle 70 will proceed along its prescribed path at a given speed. Once the vehicle reaches a given point along the path, its speed is calculated and the control unit 30 will change one or more signal lights 20 to a “go signal” and one or more to a “stop signal,” with the selection being random. In the preferred embodiment, the control unit 30 will make the change at a prescribed time so as to challenge the driver to make decisions within the prescribed reaction time. It will calculate the proper signal triggering time based on the measured speed of the vehicle 70. Sensor inputs will be positioned according to their type and interface with the control unit.

An alternate use of the lane change exercise incorporates a braking exercise. In the braking exercise, all the signal lights 20 indicate a “stop signal,” thus giving no lane for the driver to choose. The driver must then come to a complete stop before entering any lane. This alternate exercise may be incorporated into the lane selection exercise or it may stand alone as an exercise in and of itself.

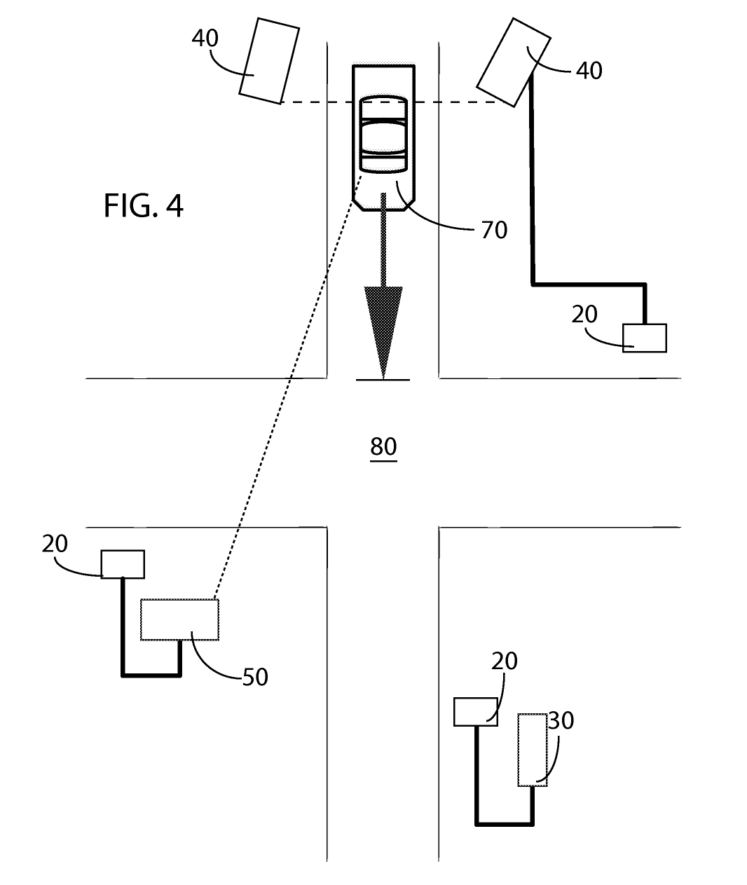

For the intersection clearance exercise, FIG. 4, the signal lights 20 are positioned in a manner to simulate an intersection, such as at right angles to each other as is depicted, each one representing incoming traffic to the intersection 80. The vehicle 70 proceeds as with the lane selection exercise, but when it reaches the intersection 80, as determined by the sensors 40, the control unit will simultaneously activate all lights and randomly select which lights change to “stop” and a time duration each light will stay in that state before changing back a “go” signal, indicating clearance of oncoming traffic from that given direction. Different times are used to represent different vehicle types, some which take longer to stop than others, and different driver interactions, such as ignoring a siren. The lights may also be programmed to return to a “stop” state. Once the intersection is “all clear” or otherwise “safe” to enter, the driver then proceeds. It should be noted that individual sensors may also be coupled to the signal lights 20, or other components, in an effort to maintain operable connection with the control unit 30. Any connection paradigm for the system is conceivable.

It should also be readily noted that since the apparatus incorporates a speed sensor 50, it may be utilized as a data collection point in other systems used coincident with the present invention.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A driving training system comprising:
a. a plurality of lane indicator signals;
b. a control unit in operable communication with the lane indicator signals;
c. at least one speed sensor, in operable communication with the control unit;
d. at least one position sensor in operable communication with the control unit;
wherein the at least one lane indicator signals are positioned in a manner to simulate a driving experience in a test area, the at least one position sensor is positioned to record a position of a vehicle as it enters the test area, the at least one speed sensor records a speed of the vehicle as it enters the test area and the control unit activates the lane indicator lights according to the simulated driving experience.

2. The driving training system of claim 1, the at least one position sensor being selected from the set of position sensors consisting of: an IR beam, magnetic induction switches, ultrasonic object sensors, air pressure switches, and RFID sensors.

3. The driving training system of claim 2, the at least one speed sensor comprising a second position sensor and a timer.

4. The driving training system of claim 2, the at least one speed sensor comprising a speed sensor selected from the set of speed sensors consisting of: a RADAR speed detector and a LIDAR speed detector.

5. The driving training system of claim 1, the at least one speed sensor comprising a second position sensor and a timer.

6. The driving training system of claim 1, the at least one speed sensor comprising a speed sensor selected from the set of speed sensors consisting of: a RADAR speed detector and a LIDAR speed detector.

7. The driving training system of claim 1, wherein the simulated driving experience is selected from a set of simulated driving experiences consisting of: an intersection clearance exercise, a lane selection exercise, and a braking exercise.

8. The driving training system of claim 1, the lane indicator signals being a part of a pre-existing system into which the driving training system is connected so as to control the lane indicator signals.

9. A method of driving simulation, the method comprising:
a. providing a plurality of signal lights operably connected to a control unit and arranged in an array, the array depending upon a chosen exercise;
b. providing at least one position detector operably connected to the control unit;
c. providing at least one speed detector operably connected to the control unit;
d. directing a vehicle towards the array of signal lights;
e. the vehicle triggering the at least one position detector and at least one speed detector, and said position and speed detectors communicating data to the control unit;
f. the control unit selectively activating signal lights according to the data received and an algorithm determined for the driving simulation.

10. The method of claim 9, the exercise being a lane selection exercise, wherein each signal light represents a different lane and the control unit selects at least one lane into which the vehicle should not proceed.

11. The method of claim 10, the control unit selecting all lanes as ones into which the vehicle should not proceed.

12. The method of claim 9, the exercise being an intersection clearance exercise, wherein each signal represents traffic oncoming into a given intersection.
